(19) United States
(12) Patent Application Publication
(10) Pub. No.: US 2019/0092699 A1
(43) Pub. Date: Mar. 28, 2019

(54) METHOD FOR MANUFACTURING CERAMIC MATRIX COMPOSITE

(71) Applicant: General Electric Company, Schenectady, NY (US)

(72) Inventors: Krishan Lal Luthra, Schenectady, NY (US); Julin Wan, Rexford, NY (US); Joseph John Shiang, Niskayuna, NY (US); Milivoj Konstantin Brun, Ballston Lake, NY (US)

(21) Appl. No.: 15/714,893

(22) Filed: Sep. 25, 2017

(51) Int. Cl. C04B 38/00; C04B 35/80; C04B 35/573

(52) U.S. Cl. CPC C04B 38/0029; C04B 38/0074; C04B 2111/40; C04B 35/573; C04B 35/80

(57) ABSTRACT

The present approach relates to the fabrication of a composite material via a multi-step heating process. In one heating stage an internal region of a preform is heated by application of electro-magnetic radiation. In another heating stage, a region near the surface of the preform is heated from the exterior inward.

### BACKGROUND

The subject matter disclosed herein relates to the manufacture of a ceramic matrix composite (CMC) material. Conventional ceramic materials are typically brittle, which creates the susceptibility of crack development. These cracks eventually propagate to fracture the material, limiting the material's strength. Ceramic matrix composites use a combination of fibers and ceramic matrix materials to impart toughness to the material. CMCs are typically prepared by infiltrating a porous fibrous preform with one or more ceramic precursor materials that are then converted into a ceramic material.

One approach to manufacture ceramic matrix composites is chemical vapor infiltration (CVI). In CVI, a porous fiber network, also called a preform, is provided. The preform comprises of layers of preform plies, which include fibers that can be unidirectional or woven. The preform plies can be of ceramic materials (e.g. silicon carbide, carbon, etc.). The preform can be held together by tooling, ‘char’ materials resulting from the burnout of a resin material or by weaving the component fibers. In a reaction chamber, the preform is heated and exposed to a certain vapor that infiltrate the preform. The preform and the vapor then react and as a result the vapor material is converted into a solid material, the ceramic matrix, which is deposited in the pores of the preform. This densification produces a material with a much lower porosity than the starting preform. Thus, the resulting CMC is at a greater density than the original preform. However, CVI typically still leaves significant porosity in the material (i.e. up to 15%) and does not result in homogenous densification throughout the material.

### BRIEF DESCRIPTION

In one embodiment, a method of creating a composite material includes heating a first region of a preform containing a plurality of plies via electro-magnetic radiation to a higher temperature than the remainder of the preform and heating a second region of the preform via an isothermal source, where the heating is performed from the exterior inward, resulting in a final structure that contains a minimum ply porosity of less than about 10%, preferably less than about 8%, and more preferably less than 6%.

In another embodiment, a method to create a composite material includes performing a cold wall chemical vapor infiltration (CVI) on a preform containing a plurality of plies to generate a partially densified structure, where the partially densified structure is densified in an interior of the preform spaced apart from a surface of the preform and performing an isothermal CVI on the partially densified structure to generate a densified structure, where the densified structure is densified in a surface adjacent region of the preform less than or equal to 1 mm from the surface of the preform.

In another embodiment, a composite material includes a plurality of densified plies stacked proximate to one another, where each densified ply has a minimum average porosity of less than 10%.

In another embodiment, a method to create a composite material includes preparing a preform comprising a plurality of plies and a plurality of fibers, where the preform has a conductive interior region, exposing the preform to an infiltrating gas wherein the infiltrating gas comprises one or more of hydrogen, methyl-trichlorosilane, boron trichloride, ammonia, tetrachlorosilane, hydrocarbon, silane, siloxane, silazane, or silicon containing gas, and exposing the preform to electromagnetic radiation such that the preform is densified.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram in an embodiment of a process to manufacture a ceramic matrix composite (CMC) using two methods of chemical vapor infiltration (CVI), in accordance with an aspect of the present disclosure;

FIG. 2 is a schematic of an apparatus used to perform cold wall CVI on a preform structure, in accordance with an aspect of the present disclosure;

FIG. 3 is a cross sectional view of a preform structure comprising a plurality of plies that further comprise of fibers and particles, in accordance with an aspect of the present disclosure;

FIG. 4 is a schematic of an apparatus used to perform conventional isothermal CVI on a preform structure, in accordance with an aspect of the present disclosure;

FIG. 5 is a cross sectional view of a preform undergoing both the cold wall and isothermal CVI process, in accordance with an aspect of the present disclosure;

FIG. 6 is a perspective view of a preform structure comprising a plurality of plies, in accordance with an aspect of the present disclosure;

FIG. 7 is a perspective view of a CMC structure after the preform structure of FIG. 6 has gone through the process of FIG. 1, in accordance with an aspect of the present disclosure;

FIG. 8 is a cross sectional view taken along A-A of the preform shown in FIG. 6, with a density profile of the preform structure, in accordance with an aspect of the present disclosure;

FIG. 9 is a cross sectional view taken along B-B of the CMC structure shown in FIG. 7, with a density profile of the CMC structure, in accordance with an aspect of the present disclosure; and

FIG. 10 is a flowchart of an embodiment of a process to measure porosity of a densified preform.

### DETAILED DESCRIPTION

The present disclosure is directed to the manufacturing of a ceramic matrix composite (CMC) using chemical vapor infiltration (CVI). Traditionally in CVI, the preform is heated to an elevated temperature within a reaction chamber and under high temperature, the preform reacts with incoming vapor to deposit material within the pores of the preform. After the vapor infiltrates the preform, the preform densifies, trapping the deposited matrix material.

In conventional isothermal CVI, where the preform is heated via thermal transport from the walls of the reactor vessel, the preform's surface is generally at a temperature similar to that at its center. However, gases diffuse in from outside of the preform to the inside. Thus, the preform's surface reacts and densifies before the preform's center. This may prevent vapor infiltration of regions further from the surface, typically leaving these non-surface adjacent region more porous than the regions immediately adjacent the surface. Thus, application of isothermal CVI to a uniformly porous preform may be best suited for use in CMC structures of less than 1 mm from surface to surface (or 0.5 mm from surface to center interior) if uniform porosity is desired.

Another method of CVI inductively heats the sample by direct absorption of electromagnetic radiation to induce measurable current flow in the preform which then resistively heats the preform in the presence of a reactive chemical vapor. These methods are part of a class of ‘cold wall’ methods in which the walls of the chamber are much colder than the preform and chemical reactions thus occur preferentially at the sample. In this case the outer surfaces of the preform sample transfer energy from the preform to the walls. Because heat transfer to the walls is faster from the surface of the preform than from the interior, if the radiation absorption profile of the preform is properly controlled, the preferential heating of the interior of the sample can be achieved. A useful absorption profile is when the preform weakly absorbs the energy uniformly throughout the preform. A more preferred strategy would be when the preform is prepared in such a manner that the radiation in preferentially absorbed in the interior of the preform. A subclass of these inductive methods, called microwave CVI, uses electromagnetic waves that have a frequency between 0.9 MHz-2.5 MHz. While the physical principles that operate in different frequency regimes are similar, the exact geometry to generate and transmit the radiation to the preform may be different. For example, using microwave radiation, there will be nodes (hot spots) a few centimeters within the cavity and the preform must be positioned accordingly. However cold wall inductive CVI relies on the conductivity of the preform fibers, which may drastically change with geometry and dynamically change with heating, therefore limiting the control of the CVI quality and potentially resulting in undesirable non-uniformities in the final CMC part. As such, homogeneity of density may still be an issue in the CMC structure under cold wall CVI.

As discussed herein, a hybrid heating approach is employed to create a composite material. Such a hybrid approach may be generalized as including two heating steps, a first heating step that heats a first region of a preform, such as an interior region, to a greater extent than the remainder of the preform. A second heating step may be performed that heats the preform from the exterior surface(s) inward. The resulting final structure may have improved porosity characteristics. The present discussion utilizes examples in which first heating step may correspond to a cold wall CVI process and the second heating step may correspond to an isothermal CVI process. It should be appreciated that such examples, however, are intended only to provide a useful context, and the present approach may apply to other combinations of suitable heating approaches. Thus, the present discussion should not be read as being limited to the present examples.

With the preceding in mind, examples in the form of a hybrid cold wall CVI and isothermal CVI process are discussed herein and may result in greater uniformity of the porosity of CMC structures. Performing cold wall CVI on areas most interior of the structure (or, more generally, not adjacent to a surface, such as greater than 0.5 mm from a surface) and isothermal CVI in the remaining surface adjacent area may result in better control of densification, reduction of porosity, and/or reduction or uniformity of the resulting porosity. Since heating via cold wall CVI relies on the conductive property of the fibers or other elements within the preform such as particulate fillers or char material remaining from a resin, modulating such fiber properties allows for selectively heating the CMC structure and may facilitate achieving a specific porosity or range of porosity. Methods to modulate the fibers include using fibers of different material composition, doping the fibers or particles in a slurry that space the fiber to increase response to radiation, adjusting the material of a connective element holding together the fiber to produce different amount of conductive char, or any combination thereof. By controlling or adjusting preform fiber composition and/or structure in this manner, cold wall CVI may be performed more efficiently across a range of preform thicknesses, but isothermal CVI remains efficient only at a thickness of the preform up to about 1-2 mm from surface to surface.

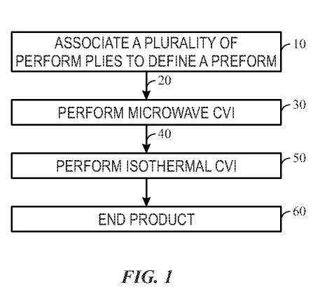

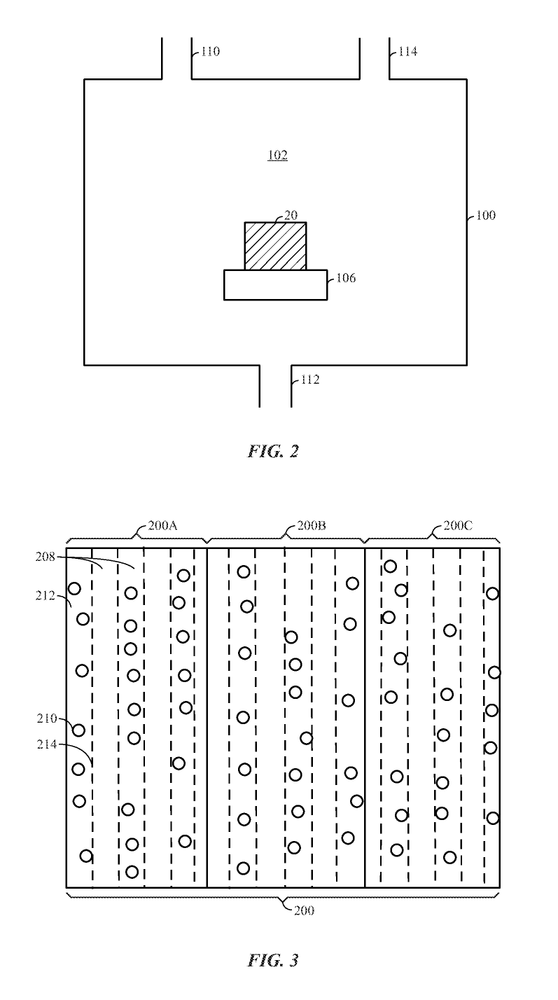

With the preceding in mind and turning to the drawings, FIG. 1 depicts steps of a method for manufacturing a CMC structure using CVI. In block 10, a plurality of preform plies are associated together to define a preform 20. The plies can have the same or different characteristics (e.g. thickness, porosity, conductivity, etc.). The effects of these characteristics will be further detailed below. To hold each ply together, a tool or a char of a resin is typically utilized. In the depicted example, the preform 20 then undergoes the cold wall CVI method of block 30, where the interior sections of preform 20 are infiltrated and densified with matrix material. FIG. 2 shows an embodiment of the cold wall CVI process.

In particular, FIG. 2 illustrates a general setup for cold wall CVI. Cold wall CVI occurs within the housing 100, which contains a reaction chamber 102. The housing 100 can contain layers of insulation and metallic covering to facilitate the process of CVI. Within reaction chamber 102, a preform 20 is placed upon a holder 106. Holder 106 can be made of an insulative material so heat is not conducted away from preform 20, or does not significantly absorb electromagnetic radiation. Preform 20 can include carbides, silicon dioxide, hafnium diboride, silicon nitride, aluminum oxide, or combinations thereof. Vapor enters reaction chamber 102 through an inlet 110 to infiltrate and react with preform 20. The vapor can include hydrogen, species that include both carbon-silicon and silicon-halogen bonds such as methyl-trichlorosilane, species that contain trivalent elements such as boron trichloride, ammonia, species that include halogen silicon bonds such as tetrachlorosilane, hydrocarbons such as methane or propane, silane, siloxane, silazane, silicon containing gas or combinations thereof. The vapors can also include hydrogen halides such as HF, HCl, HBr, and HI in varying mixtures with the carbon and silicon containing in gases. The gas composition may be changed depending upon the method of heating, for example a mixture of hydrogen, HCl, hydrocarbon and silicon containing gas may be used for the cold wall steps. The deposition of the material, such as SiC, on the surface of the pores of preform 20 creates byproducts. For example, a gas comprising methyl-trichlorsilane results in a deposit of silicon carbide and a hydrocarbon byproduct. The solid byproduct formed in this manner deposits within the pores of preform 20 and the gaseous byproduct exits through an outlet 112 of reaction chamber 102.

In addition to this setup, cold wall CVI also utilizes electromagnetic radiation (e.g., radio-wave frequencies) to facilitate heating of preform 20. Electromagnetic radiation is emitted into the reaction chamber 102 via a passageway 114. The electromagnetic waves can preferentially heat the interior (i.e., non-surface adjacent regions, such as the center) of preform 20 causing the infiltrating vapor to react with the material of the preform 20 in the interior of the preform 20 as described above. As the regions interior to the preform 20 (such as the center of the preform 20) react and densify, the temperature gradient changes so that the temperature begins to rise farther from the center (or other heated interior region), allowing these regions to react and densify. Heating via the electromagnetic radiation can also be performed in cycles. For example, the electromagnetic radiation can increase power for a time interval, then decrease the power for a time interval, before increasing power for another time interval, and repeating this process. This can allow for the vapor to continue to infiltrate the preform during a time interval of lower electromagnetic power, before further densification occurs.

Conventional ‘microwave’ units (0.9 MHz-2.5 MHz) produce radiation in the range of 10 cm-30 cm. Due to the length scale of 0.9 MHz-2.5 MHz radiation, selectively coupling radiation to the interior of a homogeneous, weakly absorbing medium is difficult on the desired length scale. Absorption that occurs near the surface of the preform will lead to some densification near the surface which can increase the ultimate porosity in the interior of the preform. Increasing the frequency is an option, but the length scale of the features in the preform may be about 50× smaller than the desired length of the radiation gradient. Thus, scattering effects are important. There is a fairly narrow range of desirable frequencies to allow for absorption of the waves without disruption by scattering. The waves that allow for absorption without scattering is generally unavailable with current microwaves in existing approaches. Furthermore, preforms of complex geometry and non-uniform parts (i.e. vanes, change in material, etc.) may be difficult to control the densification quality from location to location in a CMC.

As noted above, in the context of the cold wall CVI, utilizing absorptive effects of fiber materials may allow for control or adjustment to the heating of a preform. By spatially modulating these effects, one can selectively heat in the preform. In preforms that contain complex geometry, non-uniform parts, or any other structural arrangement that may affect the absorptive effects of the preform material, selective heating improves the uniformity of densification under CVI. Specifically, selective heating provides control of the porosity to overcome the absorption effects resulting from the preform structure. Moreover, changing the properties of the elements within the preform can overcome the required properties of a wave to generate the necessary absorption. In this manner, improved homogeneity of the densification without limitation on the preform shape or electromagnetic energy employed is possible.

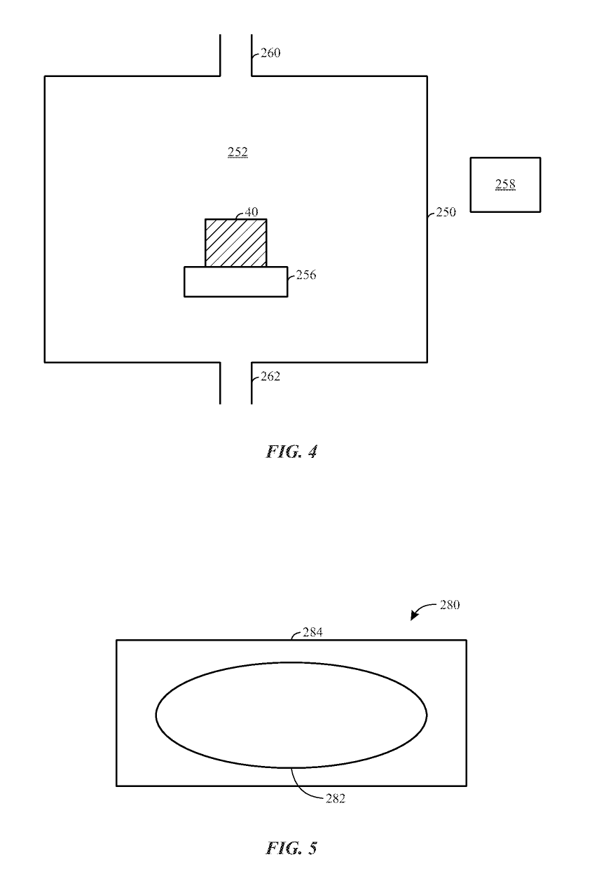

With this in mind, one method to prepare the preform for selective heating is to place fibers of higher conductivity in the center of the preform. FIG. 3 shows a cross sectional view of a preform 200, made of preform plies 200b, 200a, and 200c. Only three preform plies are shown, but preform 200 can be made of any number of preform plies. Each preform ply is further composed of fibers 208. In FIG. 3, fibers 208 are shown to be unidirectional and of the same size, with slurry particles 212 separating each fiber, but fibers can be placed in any manner (e.g. woven, multidirectional, etc.) to define a preform ply.

Fibers of higher absorption ability can be placed nearer to the center of the preform to enhance internal heating of the preform, such as in preform ply 200b in FIG. 3. The absorption ability is related to conductivity so a range of material conductivities may work well as a susceptor materials to convert the electromagnetic energy into thermal energy. By way of example, material conductivities associated with semimetals, carbides, silicon dioxide, hafnium diboride, silicon nitride, aluminum oxide, or any combination thereof may be suitable, combining useful degrees of penetration and radiation absorption. Since conductivity increases as temperature increases, these materials can also exhibit thermal runaway to further increase heating. Placing fibers of such material in the center of the preform directs electromagnetic radiation to the interior region in this manner.

As noted above, another possible method to selectively heat the preform is to change the property of particles within the preform plies. FIG. 3 shows particles 210 within slurries 212 that separate fibers 208. Slurry particles 210 can be about 5-10 microns thick, which is about as thick as each fiber 208. The particles 210 can be of a semiconductor material to facilitate the conductivity of the preform. The semiconductor material may be comprised of Group IV elements. For semiconductors, conductivity is not an intrinsic parameter, but is a function of doping. Doping the semiconductor material adjusts the coupling efficiency of the slurry particles and can increase the absorption of preform plies. For a semiconductor material comprised of Group IV elements, doping agents to dope the semiconductor material include, but are not limited to, boron, aluminum, indium, antimony, arsenic, phosphorus, gallium, or combinations thereof. Although FIG. 3 shows particles 210 of a finite shape and number within the slurry 212 of preform plies 200b, 200a, and 200c, there can be any number of particles 210 and the particles may be of any suitable shape.

For commonly used CVI material (e.g., SiC, C, etc.), this selective heating approach allows customization and/or modification of the CVI process. In many processes of CVI, including isothermal CVI, decomposition of material in gas phase often precedes deposition on the particle. Occasionally, it would be advantageous to introduce an interfering material, such as HCl in the case of deposition of SiC, to slow the reaction and the deposition to allow greater infiltration by the matrix material into the center of the preform. The shortcoming of a slowed reaction is the increase in cost to maintain the high temperature necessary for the reaction to continue. In cold wall CVI, reactions generally begin in the center of the preform, so it is less likely that the closing of pores would prevent further infiltration into the center of the preform. Thus, it may be more desirable to have quicker reactions to decrease the cost of manufacturing. One goal of selective heating is to reduce the amount of interfering material that slows down the reaction, since there is less of a need in cold wall CVI. Another goal of cold wall CVI is to have decomposition and deposition occur nearly simultaneously. Both of these goals result in a quicker reaction between the preform and the matrix material to close the pores of the preform.

Furthermore, preform 200 in FIG. 3 shows the fibers 208 as bonded or connected along adjacencies 214. In one implementation, this connection is facilitated by a resin. Prior to undergoing CVI, an elevated temperature of up to 2100° C. is applied that results in a burnout of resin to create a char. The atmosphere during the burnout process may be vacuum, or include inert gas such as helium or argon, a reactive or weakly reactive gas such as hydrogen, hydrogen chloride or nitrogen, or some combination thereof. The char may comprise carbon, silicon carbide, or silicon oxides. Prior to the burnout step, the resin material may be composed of TEOS, polycarbosilanes, polysilazanes, polysiloxanes, phenolics, furanic compounds, or any combination thereof. The char acts as a connective element to hold fibers with each other. This is especially beneficial for fibers that are not woven together and thus, are more susceptible for coming apart. The resin can be adjusted to produce different amounts of conductive char. For example, the amount of carbon content in the char can be varied. The conductive char will enable further heating by facilitating the absorption of electromagnetic radiation.

Instead of resin, fibers 208 can also be held together at adjacencies 214 with a tool. The tool can be designed from low absorbing materials such as boron nitride or alumina. The tool may contain layers of different dielectric content and be structured in such a way as to better focus electromagnetic radiation to specific hot spots. For example, the tool may be shaped to provide an absorptive cavity to enhance the intensity of radiation at the center of the preform. In any case, these methods increase the conductivity of the preform to result in better and/or targeted heating and thus, more effective densification via cold wall CVI.

Turning back to FIG. 1, the result of the cold wall CVI process of FIG. 2 is a partially densified structure 40. In certain implementations, the interior section of partially densified structure 40 is densified, whereas the outermost section surrounding the interior remains relatively porous. Partially densified structure 40 then undergoes the isothermal CVI process of block 50 to densify the remaining porous sections near the surface (i.e., within 0.5 mm-1.0 mm of the surface). As may be appreciated, this step may involve or include moving the partially densified structure 40 from one reaction chamber (configured for cold wall CVI) to another reaction chamber (configured for isothermal CVI). An embodiment of the isothermal CVI process is shown in FIG. 4.

FIG. 4 illustrates a general setup to perform isothermal CVI. The method is performed within a housing 250, which contains reaction chamber 252. In reaction chamber 252, a partially densified structure 40 is placed upon a holder 256. After the heating of reaction chamber 252, vapor enters into the reaction chamber 252 through an inlet 260. Isothermal and cold wall CVI differ, as noted above, in the manner of heating. Instead of electromagnetic radiation, isothermal CVI uses a heat source 258 (e.g. heating coils) positioned on an exterior area outside of the reaction chamber 252 to heat the walls of the reactor vessel which then heats the partially densified structure 40.

During isothermal CVI, the regions more proximate to the surface of partially densified structure 40 tend to reach reaction temperatures due to contact with the heated chamber environment, whereas the regions that are not adjacent the surface of the partially densified structure 40 (e.g., regions more proximate to the center of partially densified structure 40) tend to be at lower temperatures due to the reliance on thermal conductance of the material. The interior of the preform is at a similar temperature to the surface. However, the gases come in contact first with the outside surface first. Therefore, the reaction of the vapor and partially densified structure 40 more favorably occurs near or adjacent the surface of the partially densified structure 40. Since the reaction results in a densification and closing of the pores, as the surface adjacent regions of the partially densified structure 40 reacts, it is more difficult for the vapor to infiltrate further into the interior of partially densified structure 40. Due to its unfocused process of heat transfer, isothermal CVI may be utilized to densify multiple preforms simultaneously, i.e., in batch. Additionally, although FIG. 4 depicts isothermal CVI as occurring in a different reaction chamber than that used for cold wall CVI of FIG. 2, in certain implementations a reaction chamber may be designed that can accommodate both processes executed in sequence, such that the preform need not be moved from one chamber to the other. For example, a magnetron microwave source may direct energy to the preform via a waveguide to a relatively small opening in the chamber. The walls of the chamber may be heated using additional heating elements.

Referring back to FIG. 1, the result of the performing isothermal CVI on partially densified structure 40 is a structure that has also been infiltrated and densified in those regions proximate the surface. The result of the entire process of FIG. 1 is a densified CMC structure that in one embodiment is substantially uniformly or homogenously densified. The porosity of densified CMC structure of block 60 is smaller than that of preform 20 prior to undergoing any CVI process.

With the preceding in mind, FIG. 5 is a cross sectional view of a preform 280 that has undergone both cold wall CVI and isothermal CVI. In the depicted example, region 282 indicates the internal area within the preform that is densified by the cold wall CVI process, which could be the process shown in FIG. 2. The preform plies within region 282 can include fibers, particles, tools, resin, monolithic ceramics, previously densified ceramic material, or combinations thereof that can facilitate the absorption of electromagnetic radiation. After undergoing cold wall CVI to densify region 282, preform 280 was exposed to isothermal CVI to densify region 284, (i.e. the external or surface adjacent regions). The isothermal CVI process can be the process shown in FIG. 4. In one embodiment, isothermal CVI can be performed in the same apparatus as cold wall CVI, though in other implementations separate, specialized reaction chambers are employed. Although FIG. 5 illustrates a rectangular shape for preform 280 and an ellipse shape for region 282, the shape of preform 280 and the respective interior and surface adjacent regions 284 may be other suitable shapes. By way of example, in one implementation, for efficient densification, cold wall CVI is performed to densify the interior of the preform up to 0.5 mm from the surface, then isothermal CVI is performed to densify the remaining surface adjacent sections of the preform.

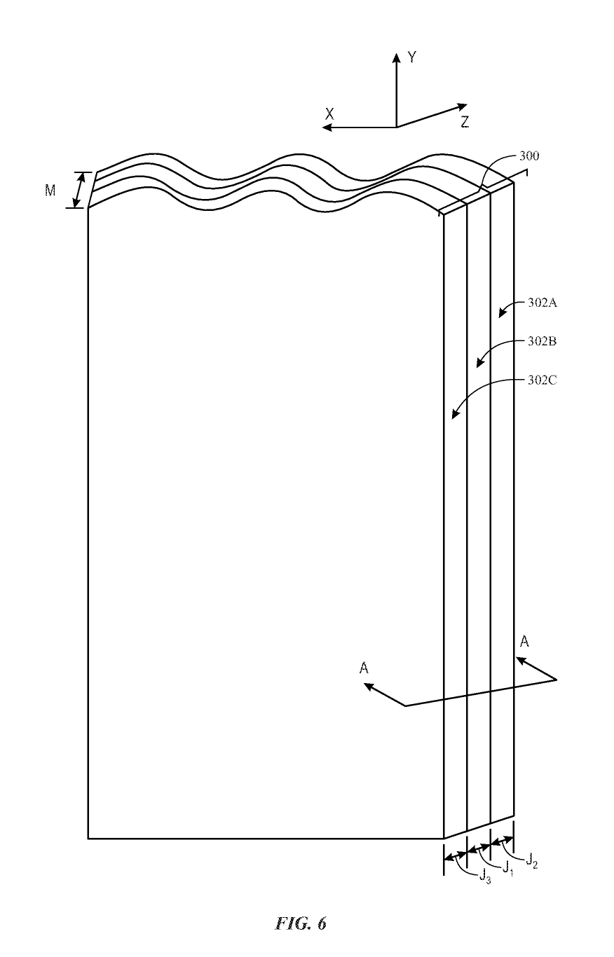

Aspects of a structure processed by the CVI approach described herein may be seen in FIG. 6-9. FIG. 6 shows a preform 300 that includes individual preform plies 302a, 302b, and 302c associated together as discussed with respect to block 10 in FIG. 1. Preform plies 302a, 302b, and 302c can have same or different characteristics (e.g. material composition, porosity, etc.) to be associated together to define a preform 300. Preform plies 302a, 302b, and 302c can have thicknesses J₁, J₂, and J₃, respectively, and preform 300 can have thickness M, where thickness M=thicknesses J₁+J₂+J₃ and thicknesses J₁, J₂, and J₃ can be the same or different thickness. Although three plies are shown in FIG. 6, there can be any suitable number of plies used to form preform 300. Furthermore, the plies are shown to be in a rectangular shape and stacked immediately proximate to each other, but plies of any shape or any suitable alignment may be associated to define preform 300.

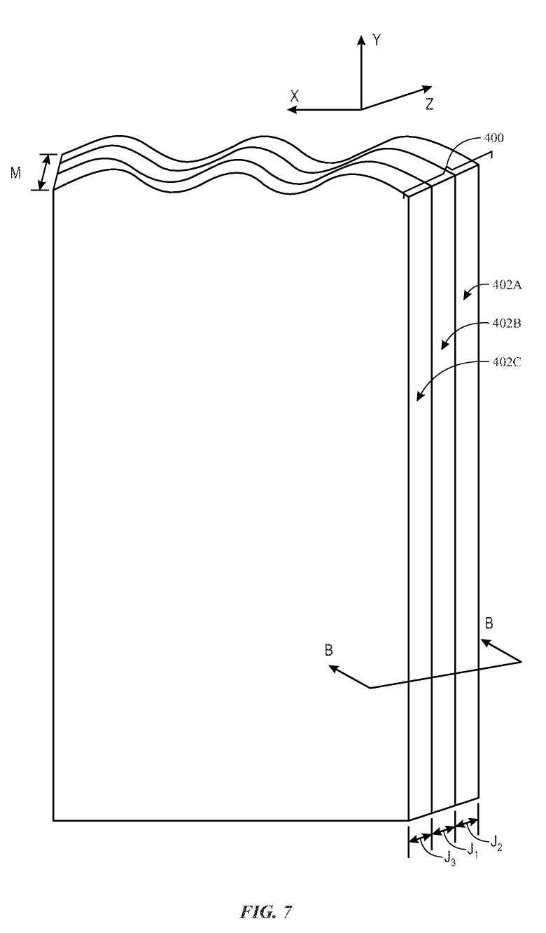

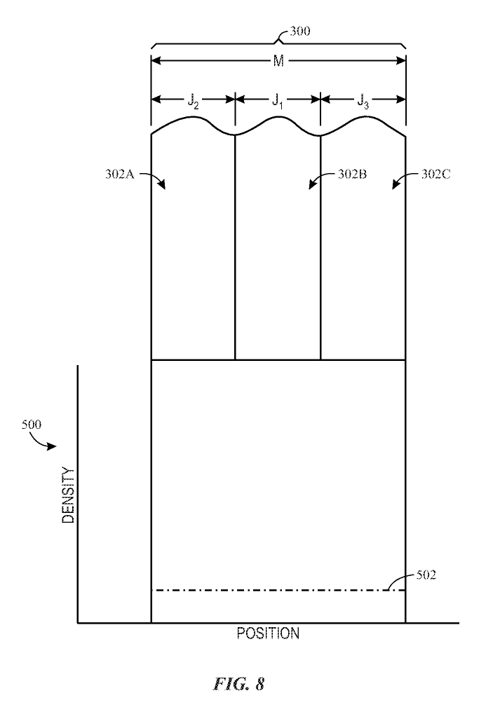

FIG. 7 shows a densified CMC structure 400 after undergoing CVI. Densified CMC structure 400 includes densified ply 402a, densified ply 402b, and densified ply 402c, with respective thicknesses J₁, J₂, and J₃. Densified CMC structure 400 has a slightly greater thickness than thickness M in preform 300. The additional thickness is due to a thin surface coat of from the reaction of the vapor with the outer surface of the preform. Typically, this surface coat is much thinner that the thickness of an individual ply. Although FIG. 7 shows three densified plies 402 that are of a rectangular shape stacked immediately proximate to each other, the densified plies can be of any number, any shape, or have any suitable alignment as previously setup in the preform structure. The possible resulting densities of performing CVI as discussed herein on preform 300 are shown in FIGS. 8 and 9.

An upper portion of FIG. 8 is a cross sectional view of preform 300 taken along sight line A-A of FIG. 6. A lower portion of FIG. 8 is a density profile 500 through a thickness of preform 300. As shown in the density profile 500, the density through preform 300 is an initial density 502. Although FIG. 8 shows preform plies 302a, 302b, and 302c as having the same density 502, the densities of preform plies 302a, 302b, and 302c can vary (i.e. need not be uniform or equivalent), depending on fabrication of the preform 300.

An upper portion of FIG. 9 is a cross sectional view of a densified CMC structure 400 taken along sight line B-B of FIG. 7. A lower portion of FIG. 9 is a density profile 504 through a thickness of densified CMC structure 400, which shows the possible benefits of performing the present combined CVI process. Referring to density profile 504, densified CMC structure 400 can have a density profile 506 after undergoing isothermal CVI, or a density profile 508 after undergoing cold wall CVI. Both density profile 506 and density profile 508 maintain a density level throughout densified CMC structure 402 that is above density 502 of preform 300, though in neither case is the density profile uniform when only one of the CVI processes is performed. Additionally, both density profile 506 and density profile 508 can have a maximum density 510, though occurring at different regions of the respective profiles.

As seen in density profile 506, the maximum densities occur at an exposed surface 404 and another exposed surface 410 of densified ply 402. Density then decreases going from the exterior to the interior of densified CMC structure 402. Though density profile 506 is shown as a U shape, the shape of density profile 506 can be any shape that contains the maximum densities on the two exposed surfaces while decreasing in density moving to the interior (e.g. ramp). Density profile 508, associated with the cold wall CVI process, shows an increase in density value going from exposed surface 404 and surface 406 until a center area of densified CMC structure 402, where it levels maximum density 510. Although density profile 508 displays a ramp and elevation shaped density profile, the density profile can be of another shape depending on the characteristics of preform plies 302a, 302b, and 302c. However, in general, the shape of density profile 508 indicating densification under cold wall CVI will contain greater densification at the regions near the interior of densified CMC structure 402 and lower densification at the regions near the exterior of densified CMC structure 402.

As will be appreciated and as discussed herein, combination of the cold wall and isothermal CVI processes may result in a structure having a more uniform density profile, as may be seen in the combination of the density profiles 506 and 508. The hybrid CVI process seeks to combine cold wall and isothermal CVI to achieve such a density profile. As mentioned, by performing cold wall CVI in the sections of a preform most interior and then performing isothermal CVI in the remaining outer sections, the characteristics of both density profiles 506 and 508 may be obtained. That is, this can result in higher densification in the interior of preform 302 than if solely isothermal CVI was performed, and also higher densification in the exterior of preform 300 than if solely cold wall CVI was performed.

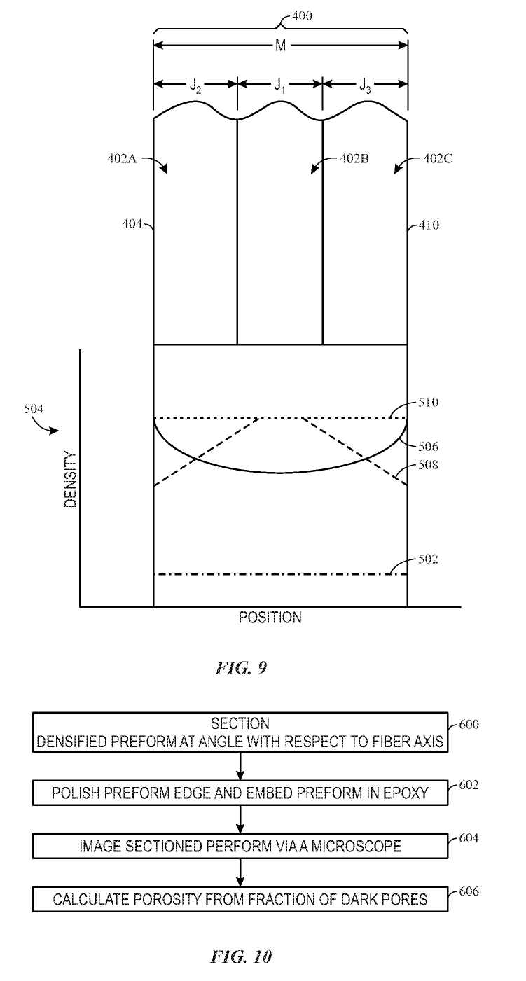

FIG. 10 illustrates a flow chart for an embodiment of a method to measure in-ply porosity, which is used to determine densification. The in-ply porosity may be measured by sectioning the densified preform in a manner that cuts in a direction non-parallel to the fiber axis in the ply (block 600). At block 602, the sectioned preform is prepared for imaging. For example, the preform's cut edge may be polished. In case of the presence of dark material in the preform, the sectioned sample can also be embedded in an epoxy prior to polishing where the epoxy contains an agent that is not present in the matrix and whose presence can be detected by the microscope (e.g., a luminescent agent if one is using optical microscopy or a metallic agent if one is using and electron microscope). At block 604, the ply may then be imaged in a microscope. The pores in the sample typically appear to be darker than the other phases present (e.g. matrix and fiber). At block 606, the relative fraction of the dark pores to the other phase may then be calculated to directly yield the porosity. In one implementation, the resulting minimum in-ply porosity from the combined CVI process may be less than 10%. In another implementation, the minimum in-ply porosity may be less than 8%. In a further aspect, the resulting maximum in-ply porosity from the combined CVI process may be less than 10%.

In a further embodiment, solely performing the cold wall CVI described in FIG. 2 on a preform structure may result in creating a CMC structure with the uniform density profile as discussed above in FIG. 9 or with another specified density profile. To obtain the specified density profile using only the cold wall approaches of FIG. 2, the preform may be prepared by using one or more methods (i.e., preparing the fibers, slurry, and resin) described in FIG. 3 so that the preform exhibits the desired internal conductivity profile or properties. In this manner, during the cold wall CVI process, the preform heats and densifies from the inside outwards. In this embodiment, the cold wall CVI process may take a longer time than the hybrid CVI process, but the second step of isothermal CVI may be omitted.

As set forth above, a hybrid approach to implement both cold wall CVI and isothermal CVI on a preform may result in a densified CMC with a more uniform density profile. For example, embodiments of the present approach may perform cold wall CVI to densify a region in the center of the preform and afterwards, perform isothermal CVI to densify a region near the surface of the preform. Cold wall CVI generally results in a densified CMC where the center of the CMC contain a higher density than the outer surfaces. Isothermal CVI generally results in a densified CMC where the outer surfaces contain a higher density than the center. As such, combining both processes to modulate the densification may combine characteristics of the respective density profiles, resulting in a more homogenous density profile throughout the CMC. Furthermore, use of the hybrid cold wall and isothermal CVI process may be implemented to as to provide an efficient fabrication flow. For example, since isothermal CVI may densify many preforms simultaneously, performing separate cold wall CVI on several individual preforms then grouping the parts together to perform isothermal CVI in a batch process may be efficient. The hybrid process may more uniformly densify a larger number of preforms than performing a single step of either cold wall or isothermal CVI. Accordingly, adjusting the material within the preform structure to optimize absorption and enhance selective heating can facilitate with the densification during cold wall CVI. This is especially beneficial in the approach utilizing two forms of CVI, because it preferentially densifies the preform at particularly selected regions in preparation for isothermal CVI in the second phase of this process. In different embodiments, the fiber within the preform, particles within the slurry between the preform's fibers, the resin holding together the preform's fibers, or any combination thereof can be adjusted. In any case, the absorption effects of the preform is increased so that the preform more efficiently converts electromagnetic energy into thermal energy. In the hybrid cold wall and isothermal CVI process, the isothermal CVI process would be limited to a thickness of the preform ranging 0.5 mm-2 mm. The cold wall CVI contains a wider range of thicknesses to apply to the preform, depending on the aforementioned factors of adjusting the fibers, slurry, and connective element within the preform. The technical effects and technical problems in the specification are examples and are not limiting. It should be noted that the embodiments described in the specification may have other technical effects and can solve other technical problems.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method to create a composite material, comprising:
heating a first region of a preform comprising a plurality of plies via electro-magnetic radiation to a higher temperature than the remainder of the preform; and
heating a second region of the preform via an isothermal source, wherein the heating is performed from the exterior inward, resulting in a final structure that comprises a minimum ply porosity of less than 10%.

2. The method of claim 1, wherein the minimum porosity is less than 8%.

3. The method of claim 1, wherein the second region of the preform comprises a region less than or equal to 2 mm from the surface of the preform.

4. The method of claim 1, wherein the step of heating the first region comprises performing a cold wall chemical vapor infiltration (CVI) on the preform.

5. The method of claim 4, wherein the step of heating the second region comprises performing an isothermal CVI on the preform.

6. The method of claim 1, wherein a plurality of fibers in the interior of the preform have higher conductivity than fibers proximate the surface of the preform.

7. The method of claim 6, wherein the plurality of fibers are held together via a resin.

8. The method of claim 7, wherein heating the first region of the preform results in a burnout of the resin provided in the preform to form a char comprising carbon, silicon carbide, silicon oxides, or any combination thereof.

9. The method of claim 1, wherein the preform further comprises a plurality of slurry particles spacing apart fibers of the preform, wherein the plurality of slurry particles comprise a semiconductor material.

10. The method of claim 9, wherein the plurality of slurry particles are doped with a doping agent comprising one or more of boron, aluminum, indium, antimony, arsenic, phosphorus, or gallium.

11. The method of claim 1, wherein heating the first region of the preform and heating the second region of the preform each comprises exposing the preform to an infiltrating gas.

12. A method to create a composite material, comprising:
performing a cold wall chemical vapor infiltration (CVI) on a preform comprising a plurality of plies to generate a partially densified structure, wherein the partially densified structure is densified in an interior of the preform spaced apart from a surface of the preform; and
performing an isothermal CVI on the partially densified structure to generate a densified structure, wherein the densified structure is densified in a surface adjacent region of the preform less than or equal to 1 mm from the surface of the preform.

13. The method of claim 12, wherein the preform further comprises a plurality of slurry particles spacing apart fibers of the preform, wherein the plurality of slurry particles comprise a semiconductor material.

14. The method of claim 13, wherein the plurality of slurry particles are doped with a doping agent comprising one or more of boron, aluminum, indium, antimony, arsenic, phosphorus, or gallium.

15. The method of claim 12, wherein performing a cold wall CVI comprises:
placing the preform within a cold wall CVI reaction chamber;
exposing the preform to an infiltrating gas wherein the infiltrating gas comprises one or more of hydrogen, methyl-trichlorosilane, boron trichloride, ammonia, tetrachlorosilane, hydrocarbon, silane, siloxane, silazane, or silicon containing gas; and
exposing the preform to electromagnetic radiation such that the infiltrating gas within the first region is densified.

16. The method of claim 15, wherein exposing the preform to electromagnetic radiation comprises cycles of alternating between electromagnetic radiation emissions at two different power levels.

17. The method of claim 12, wherein performing an isothermal CVI comprises:
placing the partially densified structure within an isothermal CVI reaction chamber;
exposing the partially densified structure to an infiltrating gas; and
exposing the partially densified structure to externally generated heat such that the infiltrating gas within the second region is densified.

18. The method of claim 12, wherein a plurality of fibers in the interior of the preform have higher conductivity than fibers proximate the surface of the preform.

19. A composite material, comprising:
a plurality of densified plies stacked proximate to one another, wherein each densified ply has a minimum average porosity of less than 10%.

20. The composite material of claim 19, wherein the minimum average porosity is less than 8%.

21. The composite material of claim 19, wherein each densified ply has a maximum average porosity of less than 10%.

22. The composite material of claim 19, wherein each of the densified plies in the plurality of densified plies comprise one or more of silicon dioxide, hafnium diboride, silicon nitride, aluminum oxide, silicon carbide, or other carbides.

23. A method to create a composite material, comprising:
preparing a preform comprising a plurality of plies and a plurality of fibers, wherein the preform has a conductive interior region;
placing the preform within a cold wall CVI reaction chamber;
exposing the preform to an infiltrating gas wherein the infiltrating gas comprises one or more of hydrogen, methyl-trichlorosilane, boron trichloride, ammonia, tetrachlorosilane, hydrocarbon, silane, siloxane, silazane, or silicon containing gas; and
exposing the preform to electromagnetic radiation such that the infiltrating gas is densified.

24. The method of claim 23, wherein preparing the preform comprises:
placing a plurality of fibers comprising a semimetal material within the preform, wherein fibers most internal to the preform are fibers of higher conductivity than fibers more proximate to the surface of the preform;
doping a plurality of slurry particles configured to space apart fibers of the preform and comprising a semiconductor material, wherein the doping agent comprising one or more of boron, aluminum, indium, antimony, arsenic, phosphorus, or gallium.
holding the plurality of fibers together via resin, wherein the resin comprises material such that a burnout of the resin forms a char comprising carbon, silicon carbide, silicon oxides, or any combination thereof.

25. The method of claim 23, wherein the electromagnetic radiation comprises a frequency of 0.9 MHz-2.5 MHz.
